(19) United States
(12) Patent Application Publication
(10) Pub. No.: US 2026/0197172 A1
(43) Pub. Date: Jul. 9, 2026

(54) AUTHENTICATION APPARATUS AND METHOD FOR CONTROLLING CLAIM ON BASIS OF TOKEN

(71) Applicant: Samsung Electronics Co., Ltd., Suwon-si (KR)

(72) Inventor: Seungchul KO, Suwon-si (KR)

(21) Appl. No.: 19/557,921

(22) Filed: Mar. 5, 2026

Related U.S. Application Data
(63) Continuation of application No. PCT/KR2024/012227, filed on Aug. 16, 2024.

(30) Foreign Application Priority Data
Oct. 13, 2023 (KR) 10-2023-0137010
Nov. 13, 2023 (KR) 10-2023-0156449

(51) Int. Cl. H04L 9/32

(52) U.S. Cl. CPC H04L 9/3213

(57) ABSTRACT

The disclosure relates to an electronic device for token-based authentication and a method thereof are provided. The method includes, when an authentication token issuance request is received from a terminal, transmitting, by the electronic device, the authentication token issuance request to an authentication server, receiving, by the electronic device, an authentication token from the authentication server, determining, by the electronic device, whether or not a claim on the authentication token needs to be reduced, when the claim on the authentication token needs to be reduced, generating, by the electronic device, a reduced authentication token, which is an authentication token having a reduced claim, by reducing the claim on the authentication token, and transmitting, by the electronic device, the reduced authentication token to the terminal.

### CROSS-REFERENCE TO RELATED APPLICATION(S

This application is a continuation application, claiming priority under 35 U.S.C. § 365(c), of an International application No. PCT/KR2024/012227, filed on August 16, 2024, which is based on and claims the benefit of a Korean patent application number 10-2023-0137010, filed on October 13, 2023, in the Korean Intellectual Property Office, and of a Korean patent application number 10-2023-0156449, filed on November 13, 2023, in the Korean Intellectual Property Office, the disclosure of each of which is incorporated by reference herein in its entirety.

### BACKGROUND

### 1. Field

The disclosure relates to an authentication apparatus and method for controlling a claim based on a token.

### 2. Description of Related Art

JavaScript object notation (JSON) web token (JWT) is a JSON object and an open standard (Request for Comments (RFC) 7519) that defines a compact and self-contained method of securely transmitting information between parties. The JWT is primarily used for authentication. Authenticated users receive the JWT, and when they need to use a resource provided by a server, they may request the resource with the JWT and be authorized to use the resource.

The JWT includes a header, payload, and signature.

The header specifies an encryption algorithm used for the signature. This encryption algorithm specified in the header is used to verify forgery or tampering of the JWT. The payload includes claims and represents data to be transmitted as the claims. The signature provides a hash value that may be used to verify authenticity of the JWT, thereby guaranteeing JWT payload values.

In addition to the claims specified in the standard, the claims of the JWT may be added depending on usage. For authentication, a scope of claims may be generated, which includes claims of a user. When a JWT is issued, claims are specified in the scope of claims. Accordingly, instead of looking up a database by a server to check the claims, the JWT may be simply verified with the signature of the JWT, and then the claims may be confirmed based on the scope of claims. Since JWT verification requires less time than database lookup, this method contributes to improved authentication performance. Furthermore, since no database is used, data does not need to be copied across multiple locations for performance improvement purposes.

In the JWT, all claims are specified within the scope of claims of the payload, and accordingly, increased claims lead to increased packet size, resulting in decreased network performance. Furthermore, since the JWT is specified in a hypertext transfer protocol (HTTP) header, there are limits in the usage by HTTP header size constraints of a server program. Even if a size limit of the server program is increased, a header size limit may not be anticipated since an intermediate server, such as a proxy between a client and a server, is uncontrollable.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an authentication apparatus and method for controlling a claim based on a token.

Additional aspects will be set forth in part in the description which follows and, in part, will be apparent from the description, or may be learned by practice of the presented embodiments.

In accordance with an aspect of the disclosure, a method performed by an electronic device for token-based authentication is provided. The method includes, when an authentication token issuance request is received from a terminal, transmitting, by the electronic device, the authentication token issuance request to an authentication server, receiving, by the electronic device, an authentication token from the authentication server, determining, by the electronic device, whether a claim of the authentication token needs to be reduced, when the claim of the authentication token needs to be reduced, by reducing the claim of the authentication token, generating, by the electronic device, a reduced authentication token, which is an authentication token having a reduced claim, and transmitting, by the electronic device, the reduced authentication token to the terminal.

In accordance with another aspect of the disclosure, an electronic device for token-based authentication is provided. The electronic device includes memory, including one or more storage media, storing instruction, and at least one processorcommunicatively coupled to the memory, wherein the instructions, when executed by the at least one processor individually or collectively, cause the electronic device to, when an authentication token issuance request is received from a terminal, transmit the authentication token issuance request to an authentication server, when an authentication token is received from the authentication server, determine whether a claim of the authentication token needs to be reduced, when the claim of the authentication token needs to be reduced, by reducing the claim of the authentication token, generate a reduced authentication token, which is an authentication token having a reduced claim, and transmit the reduced authentication token to the terminal.

In accordance with another aspect of the disclosure, one or more non-transitory computer-readable recording media storing one or more computer executable programs including computer-executable instructions that, when executed by one or more processor of an electronic device individually or collectively, cause the electronic device to perform operations are provided. The operations include when an authentication token issuance request is received from a terminal, transmitting, by the electronic device, the authentication token issuance request to an authentication server, receiving, by the electronic device, an authentication token from the authentication server, determining, by the electronic device, whether a claim of the authentication token needs to be reduced, when the claim of the authentication token needs to be reduced, by reducing the claim of the authentication token, generating, by the electronic device, a reduced authentication token, which is an authentication token having a reduced claim, and transmitting, by the electronic device, the reduced authentication token to the terminal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments in the disclosure will become apparent from the following description taken in conjunction with the accompanying drawings, in which:

FIG. 1 is a diagram illustrating a schematic configuration of an authentication system for controlling a claim based on a token, according to an embodiment of the disclosure;

FIG. 2 is a flowchart illustrating a process of issuing an authentication token by an authentication apparatus, according to an embodiment of the disclosure;

FIG. 3 is a flowchart illustrating a process of confirming, by an authentication apparatus, whether a claim has been reduced and generating a reduced authentication token, according to an embodiment of the disclosure;

FIG. 4 is a flowchart illustrating a process of generating a reduced authentication token by an authentication apparatus, according to an embodiment of the disclosure;

FIG. 5 is a flowchart illustrating a process of confirming a claim of an authentication token by an authentication apparatus, according to an embodiment of the disclosure;

FIG. 6 is a diagram illustrating a reduced authentication token, according to an embodiment of the disclosure; and

FIG. 7 is a block diagram of an electronic device, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components regardless of drawing numbers and a repeated description related thereto will be omitted. In the description of embodiments of the disclosure, detailed description of well-known related technology will be omitted when it is deemed that such description will cause ambiguous interpretation of the disclosure.

In addition, in the description of the components of the embodiments of the disclosure, terms such as first, second, A, B, (a), (b), and the like may be used. These terms are used only for the purpose of discriminating one component from another component, and the nature, the sequences, or the orders of the components are not limited by the terms. When one component is described as being "connected", "coupled", or "attached" to another component, it should be understood that one component may be connected or attached directly to the other component, and an intervening component may also be "connected", "coupled", or "attached" to the components.

The same name may be used to describe an element included in the embodiments described above and an element having a common function. Unless otherwise mentioned, the descriptions on the embodiments may be applicable to the following embodiments and thus, duplicated descriptions will be omitted for conciseness.

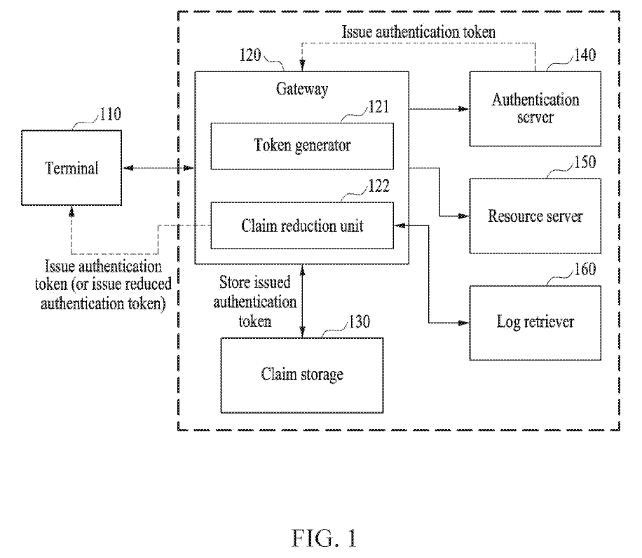

Hereinafter, an authentication apparatus and method for controlling a claim based on a token according to an embodiment of the disclosure are described with reference to FIGS. 1 to 7 attached hereto.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 is a diagram illustrating a schematic configuration of an authentication system for controlling a claim based on a token according to an embodiment of the disclosure.

Referring to FIG. 1, the authentication system may be configured to include a gateway 120, a claim storage 130, an authentication server 140, a resource server 150, and a log retriever 160.

The gateway 120 may be an intermediate server that transmits a request received from a terminal 110 to each server and may correspond to the authentication apparatus of the disclosure.

The gateway 120 may be an application programming interface (API) gateway and may process authentication/authorization and transmit requests to each service only for authenticated/authorized requests.

The authentication server 140 may be a server that issues an authentication token to the terminal 110 according to a claim. The issued authentication token may be transmitted to the terminal 110 through the gateway 120. Here, the authentication token may be a JavaScript object notation (JSON) Web Token (JWT).

The resource server 150 may be a server that manages resources to be used by the terminal 110. The claim of the authentication token may specify access rights to the resources, so the gateway 120 may transmit a request to the resource server 150 according to the access rights.

The log retriever 160 may be a search engine that may look up a history of APIs used by the terminal 110.

The claim storage 130 may be a storage that stores the claim of an unreduced authentication token received from the authentication server 140. The claim storage 130 may be looked up when confirming the claim before reduction for a reduced authentication token.

The gateway 120 may include a token generator 121 and a claim reduction unit 122.

The token generator 121 may determine whether the claim of the authentication token needs to be reduced and when the claim of the authentication token needs to be reduced, may reduce the claim of the authentication token and generate a reduced authentication token, which is an authentication token having a reduced claim.

When at least one of a case in which the authentication token includes a preset sensitive claim and a case in which the size of the authentication token is greater than a preset threshold is satisfied, the token generator 121 may determine that the claim of the authentication token needs to be reduced and may generate the reduced authentication token by excluding the claim selected by the claim reduction unit 122. Here, the preset sensitive claim may include, for example, data decryption requests, resource generation requests, and personal information requests.

The token generator 121 may generate an identification value for looking up the claim included in the authentication token, may store the claim included in the authentication token to correspond to the identification value in the claim storage 130, and excluding the claim selected by the claim reduction unit 122, may generate the reduced authentication token having a reduced claim by including the identification value and reduction indication information representing that an authentication token has a reduced claim.

When reducing the claim of the authentication token, the claim reduction unit 122 may select the claim to be excluded from among claims included in the authentication token.

The claim reduction unit 122 may select the preset sensitive claim included in the authentication token as the excluded claim when the authentication token includes the preset sensitive claim. Furthermore, when the size of the authentication token is greater than the preset threshold, the claim reduction unit 122 may select a claim to be excluded from the authentication token from among claims included in the authentication token, by considering priority, so that the size of the authentication token is less than or equal to the preset threshold and may exclude the selected claim from the authentication token.

When selecting the claim to be excluded so that the size of the authentication token is less than or equal to the preset threshold, the claim reduction unit 122 may confirm a preset priority for each claim included in the authentication token and may exclude the claim in ascending order of priority until the size of the authentication token is less than or equal to the preset threshold.

When selecting the claim to be excluded so that the size of the authentication token is less than or equal to the preset threshold, the claim reduction unit 122 may confirm priority for each claim set based on a usage frequency of a claim used by the terminal and may exclude the claim in ascending order of priority until the size of the authentication token is less than or equal to the preset threshold.

For example, the claim reduction unit 122 may set different priorities for each user. Here, the claim reduction unit 122 may select the claim to be excluded based on a least recently used (LRU) frequency, and in this case, a usage history of the claim may be searched for through the log retriever 160.

When the claim of the authentication token received from the terminal 110 is not confirmed, the gateway 120 may confirm whether the authentication token is a reduced authentication token and when the authentication token received from the terminal 110 is the reduced authentication token, may confirm the claim stored in the claim storage 130.

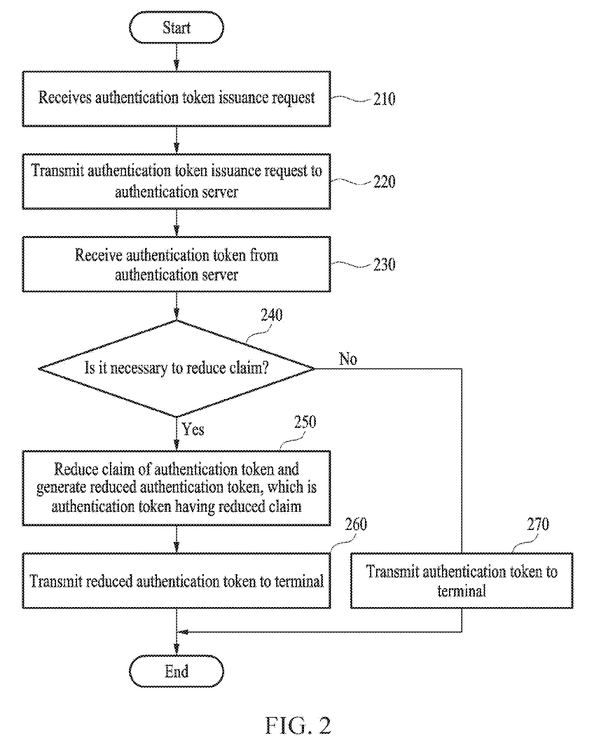

A method of issuing an authentication token based on a request from the terminal 110 and confirming a claim according to the authentication token received from the terminal 110, by the gateway 120, is described below with reference to FIGS. 2 to 5.

FIG. 2 is a flowchart illustrating a process of issuing an authentication token by an authentication apparatus according to an embodiment of the disclosure.

Referring to FIG. 2, when the authentication apparatus receives an issuance request for an authentication token from a terminal, in operation 210, the authentication apparatus may transmit the issuance request for an authentication token to an authentication server, in operation 220.

Furthermore, when the authentication apparatus receives an authentication token from the authentication server, in operation 230, the authentication apparatus may confirm whether the claim included in the authentication server needs to be reduced, in operation 240.

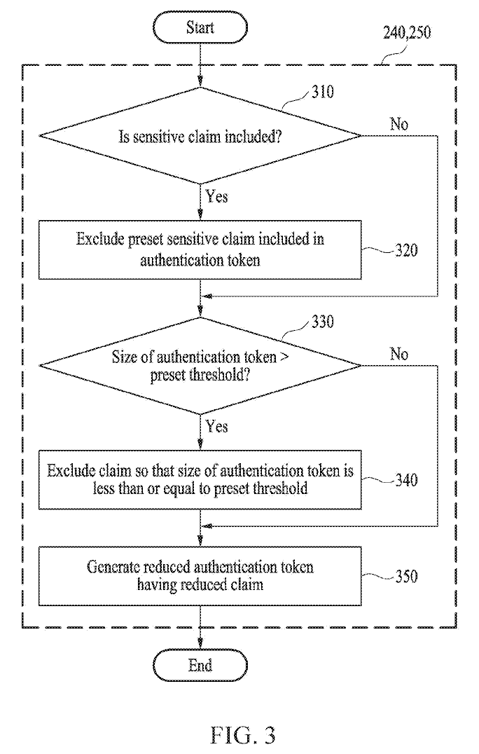

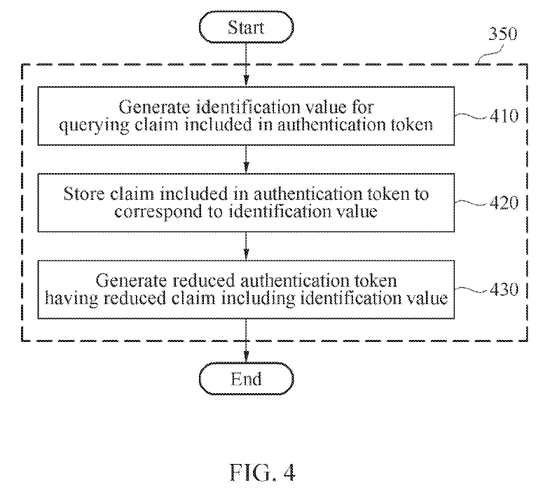

As a result of the confirming in operation 240, when the claim needs to be reduced, the authentication apparatus may reduce the claim of the authentication token and may generate a reduced authentication token, which is an authentication token having a reduced claim, in operation 250. The specific operation of generating a reduced authentication token is described below with reference to FIGS. 3 and 4.

In addition, the authentication apparatus may transmit the reduced authentication token to the terminal, in operation 260.

As a result of the confirming in operation 240, when the claim does not need to be reduced, the authentication apparatus may transmit the authentication token received from the authentication server to the terminal, in operation 270.

FIG. 3 is a flowchart illustrating a process of confirming, by an authentication apparatus, whether a claim has been reduced and generating a reduced authentication token, according to an embodiment of the disclosure.

Referring to FIG. 3, the authentication apparatus may confirm whether an authentication token includes a preset sensitive claim, in operation 310. Here, the preset sensitive claim may be a token that needs to be confirmed as to whether the authentication token is extorted and discarded. The preset sensitive claim may include, for example, data decryption requests, resource generation requests, and personal information requests.

As a result of the confirming in operation 310, when the authentication token includes the preset sensitive claim, the authentication apparatus may exclude the preset sensitive claim included in the authentication token, in operation 320.

As a result of the confirming in operation 310, when the authentication token does not include the preset sensitive claim, the authentication apparatus may proceed to operation 330 without performing operation 320.

Furthermore, the authentication apparatus may confirm whether the size of the authentication token is greater than a preset threshold, in operation 330.

As a result of the confirming in operation 330, when the size of the authentication token is greater than the preset threshold, the authentication apparatus may selectively exclude the included claim so that the size of the authentication token is less than or equal to the preset threshold, in operation 340.

As a result of the confirming in operation 330, when the size of the authentication token is not greater than the preset threshold, the authentication apparatus may proceed to operation 350 without performing operation 340.

In addition, the authentication apparatus may generate a reduced authentication token having a reduced claim, in operation 350.

FIG. 4 is a flowchart illustrating a process of generating a reduced authentication token by an authentication apparatus, according to an embodiment of the disclosure.

Referring to FIG. 4, the authentication apparatus may generate an identification value for looking up a claim included in an authentication token later, in operation 410. Here, the identification value may be a serial number or a randomly generated value.

In addition, the authentication apparatus may store the claim included in the authentication token to correspond to the identification value, in operation 420.

Furthermore, the authentication apparatus may generate a reduced authentication token having a reduced claim including an identification value, in operation 430. Here, the reduced authentication token may further include reduction indication information representing that an authentication token has a reduced claim.

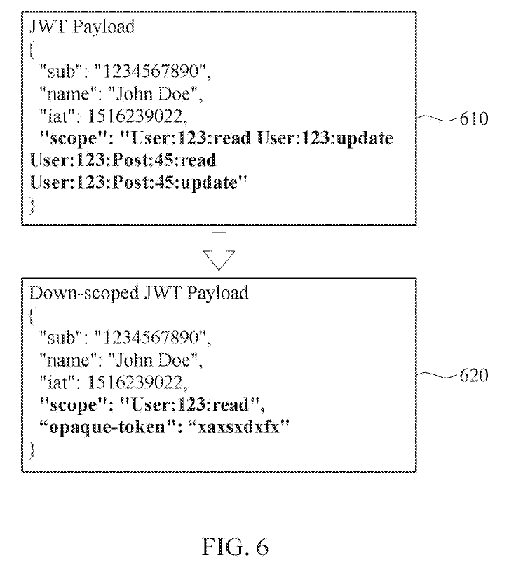

FIG. 6 is a diagram illustrating a reduced authentication token, according to an embodiment of the disclosure.

Referring to FIG. 6, an authentication token 610 may be a JWT that is an unreduced authentication token received from an authentication server.

An authentication token 620 may be a reduced authentication token having a reduced claim generated by an authentication apparatus. The reduced authentication token may also be a JWT.

The claim included in the authentication token 610 may be "User:123:read User:123:update User:123:Post:45:read User:123:Post:45:update".

Furthermore, the claim included in the reduced authentication token 620 may be "User:123:read".

It may be confirmed that the reduced authentication token 620 includes "opaque-token", which is reduction indication information representing that an authentication token has a reduced claim, and "xaxsxdxfx", which corresponds to an identification value used to retrieve a stored claim later.

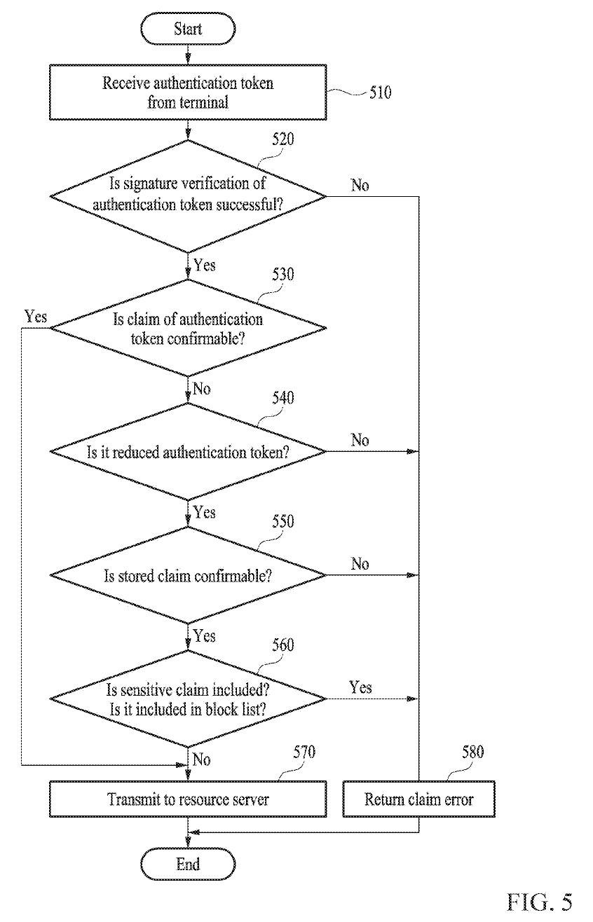

FIG. 5 is a flowchart illustrating a process of confirming a claim of an authentication token by an authentication apparatus, according to an embodiment of the disclosure.

Referring to FIG. 5, when the authentication apparatus receives an authentication token from a terminal, in operation 510, the authentication apparatus may verify a signature of the authentication token to confirm whether the verification is successful, in operation 520.

As a result of the confirming in operation 520, when the signature verification of the authentication token is successful, the authentication apparatus may confirm whether the claim of the authentication token is confirmable, in operation 530. Here, the confirming of the claim of the authentication token is to confirm whether the claim required to use resources requested by the terminal is confirmable.

As a result of the confirming in operation 530, when the claim of the authentication token is not confirmable, the authentication apparatus may confirm whether the received authentication token is a reduced authentication token, in operation 540. Here, the authentication apparatus may confirm whether the received authentication token includes reduction indication information and whether the received authentication token is the reduced authentication token.

As a result of the confirming in operation 530, when the claim of the authentication token is confirmable, the authentication apparatus may transmit a request included in the received authentication token to a resource server, in operation 570.

As a result of the confirming in operation 540, when the received authentication token is the reduced authentication token, the authentication apparatus may confirm whether a stored claim is confirmable, in operation 550. Here, the authentication apparatus may use an identification value included in the reduced authentication token to confirm the stored claim corresponding to the reduced authentication token in a storage in which the claim of an original authentication token is stored. For example, as a result of retrieving the storage using the identification value by the authentication apparatus, when the stored claim is found, the authentication apparatus may determine that the stored claim is confirmable.

As a result of confirming in operation 550, when the stored claim is confirmable, the authentication apparatus may confirm whether the stored claim includes a preset sensitive claim and whether the received authentication token is included in a block list, in operation 560.

As a result of confirming in operation 560, when the preset sensitive claim is not included in the stored claim, or when the received authentication token is not included in the block list even if the preset sensitive claim is included, the authentication apparatus may transmit the request included in the received authentication token to the resource server, in operation 570.

Furthermore, when the signature verification of the authentication token fails as a result of the confirming in operation 520, when the authentication token is not a reduced authentication token as a result of the confirming in operation 540, when the stored claim is not confirmable as a result of the confirming in operation 550, or when the stored claim includes the preset sensitive claim and the received authentication token is included in the block list as a result of the confirming in operation 560, the authentication apparatus may return a claim error corresponding to each case to the terminal, in operation 580.

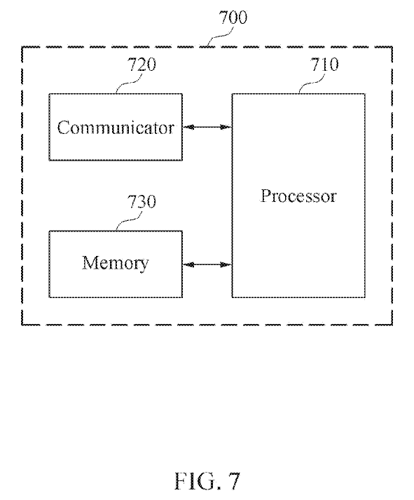

Furthermore, the gateway 120 corresponding to the authentication apparatus of FIG. 1 may be configured in the form of an electronic device 700 as shown in FIG. 7.

FIG. 7 is a block diagram of an electronic device according to an embodiment of the disclosure.

Referring to FIG. 7, the electronic device 700 may be configured to include a processor 710, a communicator 720, and memory 730.

The processor 710 may execute, for example, software (e.g., a program) to control at least one other component (e.g., a hardware or software component) of the electronic device 700 connected to the processor 710 and may perform various data processing or operations. According to an embodiment of the disclosure, as at least a part of data processing or operations, the processor 710 may store instructions or data received from another component (e.g., the communicator 720) in the memory 730, may process the instructions or the data stored in the memory 730, and may store result data in the memory 730. According to an embodiment of the disclosure, the processor 710 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a CP) that is operable independently of or in conjunction with the main processor.

Furthermore, the processor 620 may perform the operation of the gateway 120 of FIG. 1 and the operation of the authentication apparatus of FIGS. 2 to 5.

The communicator 720 may support establishing a communication channel or wireless communication channel between the electronic device 700 and an external device (e.g., the authentication server 140, the resource server 150, and the log retriever 160) and performing communication through the established communication channel. The communicator 720 may include one or more communication processors that operate independently of the processor 710 (e.g., an application processor) and support direct (e.g., wired) communication or wireless communication.

The memory 730 may store a variety of data used by at least one component (e.g., the processor 710) of the electronic device 700. The various pieces of data may include, for example, software (e.g., a program) and input data or output data for a command related thereto. The memory 730 may include volatile memory or non-volatile memory. The program may be stored as software in the memory 730 and may include, for example, an operating system, middleware, or an application.

Furthermore, the memory 730 may perform a function of the claim storage 130 of FIG. 1.

According to an embodiment of the disclosure, a token-based authentication method may include, when an authentication token issuance request is received from a terminal, transmitting the authentication token issuance request to an authentication server, receiving an authentication token from the authentication server, determining whether a claim of the authentication token needs to be reduced, when the claim of the authentication token needs to be reduced, by reducing the claim of the authentication token, generating a reduced authentication token, which is an authentication token having a reduced claim, and transmitting the reduced authentication token to the terminal.

According to an embodiment of the disclosure, the token-based authentication method may further include, when the claim of the authentication token does not need to be reduced, transmitting the authentication token to the terminal.

According to an embodiment of the disclosure, the reduced authentication token may include reduction indication information representing that an authentication token has a reduced claim.

According to an embodiment of the disclosure, the authentication token may be a JWT.

According to an embodiment of the disclosure, the determining of whether the claim of the authentication token needs to be reduced may include determining that the claim of the authentication token needs to be reduced when at least one of a case in which the authentication token includes a preset sensitive claim and a case in which a size of the authentication token is greater than a preset threshold is satisfied.

According to an embodiment of the disclosure, the generating of the reduced authentication token may include generating an identification value for looking up the claim included in the authentication token, storing the claim included in the authentication token to correspond to the identification value, when the authentication token includes the preset sensitive claim, excluding the preset sensitive claim included in the authentication token, when the size of the authentication token is greater than the preset threshold, selecting a claim to be excluded from the authentication token from among claims included in the authentication token, by considering priority, so that the size of the authentication token is less than or equal to the preset threshold and excluding the selected claim from the authentication token, and generating the reduced authentication token having the reduced claim including the identification value.

According to an embodiment of the disclosure, the selecting of the claim to be excluded from the authentication token from among claims included in the authentication token, by considering priority, so that the size of the authentication token is less than or equal to the preset threshold and the excluding of the selected claim from the authentication token may include confirming a preset priority for each claim included in the authentication token and excluding the claim in ascending order of priority until the size of the authentication token is less than or equal to the preset threshold.

According to an embodiment of the disclosure, the selecting of the claim to be excluded from the authentication token from among claims included in the authentication token, by considering priority, so that the size of the authentication token is less than or equal to the preset threshold and the excluding of the selected claim from the authentication token may include confirming priority for each claim set based on a usage frequency of a claim used by the terminal and excluding the claim in ascending order of priority until the size of the authentication token is less than or equal to the preset threshold.

According to an embodiment of the disclosure, the token-based authentication method may further include, when the claim of the authentication token received from the terminal is not confirmed, confirming whether the authentication token is a reduced authentication token and when the authentication token received from the terminal is a reduced authentication token, confirming a stored claim.

According to an embodiment of the disclosure, when the claim of the authentication token received from the terminal is not confirmed, the confirming of whether the authentication token is a reduced authentication token may include, when the authentication token includes the reduction indication information, determining the authentication token as the reduced authentication token.

According to an embodiment of the disclosure, when the authentication token received from the terminal is the reduced authentication token, the confirming of the stored claim may include retrieving and confirming stored claim information corresponding to identification information included in the reduced authentication token.

According to an embodiment of the disclosure, the token-based authentication method may further include, as a result of confirming the stored claim, when a preset sensitive claim is included in the stored claim, and when the authentication token is included in a block list, transmitting to the terminal that an error has occurred in the claim.

According to an embodiment of the disclosure, the token-based authentication method may further include, as a result of confirming the stored claim, when a preset sensitive claim is not included in the stored claim, or when the authentication token is not included in a block list even if the preset sensitive claim is included, transmitting a request included in the authentication token to a resource server.

According to an embodiment of the disclosure, a token-based authentication apparatus may include memory and a processor, wherein the processor may be configured to, when an authentication token issuance request is received from a terminal, transmit the authentication token issuance request to an authentication server, when an authentication token is received from the authentication server, determine whether a claim of the authentication token needs to be reduced, when the claim of the authentication token needs to be reduced, by reducing the claim of the authentication token, generate a reduced authentication token, which is an authentication token having a reduced claim, and transmit the reduced authentication token to the terminal.

According to an embodiment of the disclosure, the processor may be configured to, when the claim of the authentication token does not need to be reduced, transmit the authentication token to the terminal.

According to an embodiment of the disclosure, the reduced authentication token may include reduction indication information representing that an authentication token has a reduced claim.

According to an embodiment of the disclosure, the processor may be configured to, when determining whether the claim of the authentication token needs to be reduced, determine that the claim of the authentication token needs to be reduced when at least one of a case in which the authentication token includes a preset sensitive claim and a case in which a size of the authentication token is greater than a preset threshold is satisfied.

According to an embodiment of the disclosure, the processor may be configured to, when generating the reduced authentication token, generate an identification value for looking up the claim included in the authentication token, store the claim included in the authentication token to correspond to the identification value, when the authentication token includes the preset sensitive claim, exclude the preset sensitive claim included in the authentication token, when the size of the authentication token is greater than the preset threshold, select a claim to be excluded from the authentication token from among claims included in the authentication token, by considering priority, so that the size of the authentication token is less than or equal to the preset threshold and exclude the selected claim from the authentication token, and generate the reduced authentication token having the reduced claim including the identification value.

According to an embodiment of the disclosure, the processor may be configured to, when the claim of the authentication token received from the terminal is not confirmed, confirm whether the authentication token is a reduced authentication token and when the authentication token received from the terminal is a reduced authentication token, confirm a stored claim corresponding to the reduced authentication token in the memory.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments of the disclosure, or they may be of the kind well-known and available to those having skill in the computer software arts. Examples of non-transitory computer-readable media include magnetic media, such as hard disks, floppy disks, and magnetic tape, optical media, such as CD-ROM discs or DVDs, magneto-optical media, such as optical discs, and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments of the disclosure, or vice versa.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or rearranged or supplemented by other components or their equivalents.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments therefore, it will be understood by those skilled in the art that various changes in form and details may be made therein without departing from the spirit and scope of the disclosure as defined by the appended claims and their equivalents.

What is claimed is:

1. A method performed by an electronic device for token-based authentication, the method comprising:
when an authentication token issuance request is received from a terminal, transmitting, by the electronic device, the authentication token issuance request to an authentication server;
receiving, by the electronic device, an authentication token from the authentication server;
determining, by the electronic device, whether a claim of the authentication token needs to be reduced;
when the claim of the authentication token needs to be reduced, by reducing the claim of the authentication token, generating, by the electronic device, a reduced authentication token, which is an authentication token having a reduced claim; and
transmitting, by the electronic device, the reduced authentication token to the terminal.

2. The method of claim 1, further comprising:
when the claim of the authentication token does not need to be reduced, transmitting the authentication token to the terminal.

3. The method of claim 1, wherein the reduced authentication token comprises reduction indication information representing that an authentication token has a reduced claim.

4. The method of claim 1, wherein the authentication token is a JavaScript object notation (JSON) web token (JWT).

5. The method of claim 1, wherein the determining of whether the claim of the authentication token needs to be reduced comprises:
determining that the claim of the authentication token needs to be reduced when at least one of a case in which the authentication token includes a preset sensitive claim and a case in which a size of the authentication token is greater than a preset threshold is satisfied.

6. The method of claim 5, wherein the generating of the reduced authentication token comprises:
generating an identification value for looking up the claim included in the authentication token;
storing the claim included in the authentication token to correspond to the identification value;
when the authentication token includes the preset sensitive claim, excluding the preset sensitive claim included in the authentication token;
when the size of the authentication token is greater than the preset threshold, selecting a claim to be excluded from the authentication token from among claims included in the authentication token, by considering priority, so that the size of the authentication token is less than or equal to the preset threshold and excluding the selected claim from the authentication token; and
generating the reduced authentication token having the reduced claim including the identification value.

7. The method of claim 6, wherein the selecting of the claim to be excluded from the authentication token from among claims included in the authentication token, by considering priority, so that the size of the authentication token is less than or equal to the preset threshold and the excluding of the selected claim from the authentication token comprises:
confirming a preset priority for each claim included in the authentication token and excluding the claim in ascending order of priority until the size of the authentication token is less than or equal to the preset threshold.

8. The method of claim 6, wherein the selecting of the claim to be excluded from the authentication token from among claims included in the authentication token, by considering priority, so that the size of the authentication token is less than or equal to the preset threshold and the excluding of the selected claim from the authentication token comprises:
confirming priority for each claim set based on a usage frequency of a claim used by the terminal and excluding the claim in ascending order of priority until the size of the authentication token is less than or equal to the preset threshold.

9. The method of claim 1, further comprising:
when the claim of the authentication token received from the terminal is not confirmed, confirming whether the authentication token is a reduced authentication token; and
when the authentication token received from the terminal is a reduced authentication token, confirming a stored claim.

10. The method of claim 9, wherein when the claim of the authentication token received from the terminal is not confirmed, the confirming of whether the authentication token is a reduced authentication token comprises:
when the authentication token includes the reduction indication information, determining the authentication token as the reduced authentication token.

11. The method of claim 9, wherein when the authentication token received from the terminal is the reduced authentication token, the confirming of the stored claim comprises:
retrieving and confirming stored claim information corresponding to identification information included in the reduced authentication token.

12. The method of claim 9, further comprising:
as a result of confirming the stored claim, when a preset sensitive claim is included in the stored claim, and when the authentication token is included in a block list, transmitting to the terminal that an error has occurred in the claim.

13. The method of claim 9, further comprising:
as a result of confirming the stored claim, when a preset sensitive claim is not included in the stored claim, or when the authentication token is not included in a block list even if the preset sensitive claim is included, transmitting a request included in the authentication token to a resource server.

14. One or more non-transitory computer-readable storage media storing one or more computer programs including computer-executable instruction that, when executed by one or more processors of an electronic device individually or collectively, cause the electronic device to perform operations, the operations comprising:
when an authentication token issuance request is received from a terminal, transmitting, by the electronic device, the authentication token issuance request to an authentication server;
receiving, by the electronic device, an authentication token from the authentication server;
determining, by the electronic device, whether a claim of the authentication token needs to be reduced;
when the claim of the authentication token needs to be reduced, by reducing the claim of the authentication token, generating, by the electronic device, a reduced authentication token, which is an authentication token having a reduced claim; and
transmitting, by the electronic device, the reduced authentication token to the terminal.

15. An electronic device for token-based authentication, the electronic device comprising:
memory, comprising one or more storage media, storing instruction; and
at least one processorcommunicatively coupled to the memory,
wherein the instructions, when executed by the at least one processor individually or collectively, cause the electronic device to:
when an authentication token issuance request is received from a terminal, transmit the authentication token issuance request to an authentication server,
when an authentication token is received from the authentication server, determine whether a claim of the authentication token needs to be reduced,
when the claim of the authentication token needs to be reduced, by reducing the claim of the authentication token, generate a reduced authentication token, which is an authentication token having a reduced claim, and
transmit the reduced authentication token to the terminal.

16. The electronic device of claim 15, wherein the instructions, when executed by the at least one processor individually or collectively, further cause the electronic device to:
when the claim of the authentication token does not need to be reduced, transmit the authentication token to the terminal.

17. The electronic device of claim 15, wherein the reduced authentication token comprises reduction indication information representing that an authentication token has a reduced claim.

18. The electronic device of claim 15, wherein the authentication token is a JavaScript object notation (JSON) web token (JWT).

19. The electronic device of claim 15, wherein the instructions, when executed by the at least one processor individually or collectively, further cause the electronic device to:
determine that the claim of the authentication token needs to be reduced when at least one of a case in which the authentication token includes a preset sensitive claim and a case in which a size of the authentication token is greater than a preset threshold is satisfied.

20. The electronic device of claim 19, wherein the instructions, when executed by the at least one processor individually or collectively, further cause the electronic device to:
generate an identification value for looking up the claim included in the authentication token,
store the claim included in the authentication token to correspond to the identification value,
when the authentication token includes the preset sensitive claim, exclude the preset sensitive claim included in the authentication token,
when the size of the authentication token is greater than the preset threshold, select a claim to be excluded from the authentication token from among claims included in the authentication token, by considering priority, so that the size of the authentication token is less than or equal to the preset threshold and excluding the selected claim from the authentication token, and
generate the reduced authentication token having the reduced claim including the identification value.
